(19) United States
(12) Patent Application Publication
(10) Pub. No.: US 2023/0387446 A1
(43) Pub. Date: Nov. 30, 2023

(54) Pouch Sealing Apparatus

(71) Applicant: LG Energy Solution, Ltd., Seoul (KR)

(72) Inventors: Ja Young Seo, Daejeon (KR); Dae Hong Kim, Daejeon (KR); Sae Young Oh, Daejeon (KR)

(73) Assignee: LG Energy Solution, Ltd., Seoul (KR)

(21) Appl. No.: 18/032,587

(22) PCT Filed: Jul. 6, 2022
(86) PCT No.: PCT/KR2022/009735

§ 371 Date: Apr. 19, 2023

(30) Foreign Application Priority Data
Jul. 8, 2021 (KR) 10-2021-0089407

(51) Int. Cl. H01M 10/04; H01M 50/105

(52) U.S. Cl. CPC H01M 10/0404; H01M 50/105

(57) ABSTRACT

A pouch sealing apparatus configured to seal a pouch for batteries includes an upper pouch and a lower pouch, the pouch being configured to receive an electrode assembly and an electrolytic solution. The pouch sealing apparatus includes a mounting unit configured to allow a pouch receiving portion to be seated thereon, a press roller configured to move the electrolytic solution into the pouch receiving portion while rolling from open ends of the upper pouch and the lower pouch toward the pouch receiving portion, and a sealing tool configured to seal parts of the upper pouch and the lower pouch to be sealed, wherein the press roller fuses the upper pouch and the lower pouch in contact with each other while being heated by a heating portion added to a part of the roller and rolling.

### CROSS-REFERENCE TO RELATED APPLICATIONS

This application is a national phase entry under 35 U.S.C. § 371 of International Application No. PCT/KR2022/009735 filed on Jul. 6, 2022, which claims priority from Korean Patent Application No. 10-2021-0089407 filed on Jul. 8, 2021, all of which are incorporated herein by reference.

### TECHNICAL FIELD

The present invention relates to a pouch sealing apparatus. More particularly, the present invention relates to a pouch sealing apparatus capable of easily performing sealing at a predetermined position of a pouch to be sealed while preventing leakage of an electrolytic solution out of a gas pocket portion.

### BACKGROUND ART

Secondary batteries may be classified depending on the structure of an electrode assembly including a positive electrode, a separator, and a negative electrode. Typically, the electrode assembly may be a jelly-roll type (wound type) electrode assembly, which is configured to have a structure in which long sheet type positive electrodes and long sheet type negative electrodes are wound in the state in which separators are interposed therebetween, a stacked type electrode assembly, which is configured to have a structure in which a plurality of positive electrodes and a plurality of negative electrodes each cut to a predetermined size are sequentially stacked in the state in which separators are interposed therebetween, or a stacked and folded type electrode assembly, which is configured to have a structure in which bi-cells or mono-cells, each of which is configured such that positive electrodes and negative electrodes each having a predetermined size are stacked in the state in which separators are interposed therebetween, are wound using a separation film.

Secondary batteries may be classified into a cylindrical battery, a prismatic battery, and a pouch-shaped battery depending on the shape thereof. Thereamong, the pouch-shaped battery is manufactured using a pouch sheathing member constituted by a multilayered film including a metal layer (foil) and synthetic resin layers formed on an upper surface and a lower surface of the metal layer by coating, and therefore the weight of the pouch-shaped battery is remarkably reduced, compared to the cylindrical battery or the prismatic battery, which uses a metal can, whereby there are advantages in that it is possible to reduce the weight of the battery and to modify the battery into various forms.

In general, the pouch sheathing member is constituted by a lower sheathing member configured to receive an electrode assembly and an upper sheathing member configured to seal an upper part of the lower sheathing member. The electrode assembly is received in a receiving portion of the lower sheathing member, an edge of the receiving portion of the lower sheathing member and an edge of the upper sheathing member corresponding thereto are brought into tight contact with each other, parts of the tight contact portions are thermally fused, an electrolytic solution is introduced into the pouch sheathing member, and the remaining parts of the tight contact portions are sealed, whereby a secondary battery is temporarily assembled.

In an activation process, the secondary battery is loaded into a predetermined jig and the secondary battery is charged and discharged under conditions necessary for activation in order to achieve smooth current conduction. For a secondary battery, a process of activating a positive electrode active material and an activation process for creating a stable solid electrolyte interface (SEI) at a negative electrode must be essentially performed first during a first cycle due to characteristics thereof. A large amount of gas is generated in the secondary battery cell as the result of such activation processes. Subsequently, the generated gas is removed through an open or incised discharge port, and the gas discharge portion is thermally fused again so as to be sealed. A process of discharging the gas from the secondary battery as described above is generally referred to as a degassing process. After the degassing process, sealing is performed to complete the secondary battery.

While the gas generated in the secondary battery moves to a gas pocket portion, some of the electrolytic solution remains in a connection portion between the secondary battery and the gas pocket portion, and the force of sealing at the connection portion is greatly reduced by the electrolytic solution that remains in the connection portion. Some electrolytic solution moves to the gas pocket portion.

Since the pouch-shaped secondary battery is easily deformed, it is difficult to accurately set a sealing point. The pouch-shaped secondary battery is less deformed when the pouch-shaped secondary battery is laid flat than when the pouch-shaped secondary battery is stood. As shown in FIG. 1, therefore, a pouch-shaped secondary battery is inserted into a sealing apparatus in the state in which the pouch-shaped secondary battery is laid flat, and sealing is performed by pressing of the sealing apparatus. An upper pouch 11 and a lower pouch 12 are inserted between an upper sealing tool 21 and a lower sealing tool 22, and the upper sealing tool 21 and the lower sealing tool 22 are moved toward each other in order to perform pressing, heating, and sealing. This method has a problem in that a residual electrolytic solution remains in a sealed portion, whereby sealing quality is lowered.

Korean Patent Application Publication No. 2019-0072962 relates to a secondary battery manufacturing apparatus including an electrolytic solution removing device configured to push an electrolytic solution that remains in a connection portion of a pouch to a gas pocket portion in order to remove the electrolytic solution, a sealing device configured to seal the connection portion of the pouch, from which the electrolytic solution has been removed by the electrolytic solution removing device, and a discharging device configured to discharge the pouch, the connection portion thereof having been sealed by the sealing device.

In Korean Patent Application Publication No. 2019-0072962, the pouch, from which the electrolytic solution has been removed by the electrolytic solution removing device, is transferred to the sealing device, which is separately provided at a rear end of the secondary battery manufacturing apparatus, and is sealed by the sealing device, wherein electrolytic solution removal and sealing are performed through a two-step process.

In Japanese Registered Patent Publication No. 6204497, a residual electrolytic solution is removed using a roller; however, a separate sealing process is performed after an electrolytic solution removal process, as in Korean Patent Application Publication No. 2019-0072962.

In Korean Registered Patent Publication No. 1417152, pressing is performed using a roller in order to reduce a possibility of mixed sealing due to an electrolytic solution; however, the roller alone is used as a sealing unit.

### DISCLOSURE

### Technical Problem

The present disclosure has been made in view of the above problems, and it is an object of the present disclosure to provide a pouch sealing apparatus capable of discharging or removing an electrolytic solution from a sealed portion of a pouch-shaped secondary battery and accurately performing sealing while maintaining the shape of a part of a pouch to be sealed.

### Technical Solution

In an embodiment of the present invention provides a pouch sealing apparatus configured to seal a pouch for batteries including an upper pouch and a lower pouch, the pouch being configured to receive an electrode assembly and an electrolytic solution, the pouch sealing apparatus including a mounting unit configured to allow a pouch receiving portion to be seated thereon, a press roller configured to move the electrolytic solution into the pouch receiving portion while rolling from open ends of the upper pouch and the lower pouch toward the pouch receiving portion, and a sealing tool configured to seal parts of the upper pouch and the lower pouch to be sealed, wherein the press roller fuses the upper pouch and the lower pouch in contact with each other by a heating portion added to a part of the roller while rolling.

The press roller may include an upper press roller and a lower press roller located such that the parts of the upper pouch and the lower pouch to be sealed are disposed therebetween.

The heating portion of at least one of the upper press roller and the lower press roller of the press roller may be configured such that the temperature thereof is increased up to 250° C., and the upper press roller and the lower press roller may be spaced apart from each other by a predetermined distance.

The upper press roller may be located at upper ends of a pair of upper rails horizontally located spaced apart from each other by a predetermined distance, the lower press roller may be located at upper ends of a pair of lower rails horizontally located spaced apart from each other by a predetermined distance, the pair of upper rails and the pair of lower rails may be located so as to correspond to each other up and down, and the upper press roller and the lower press roller may horizontally roll on the pair of upper rails and the pair of lower rails, respectively.

The vertical distance between the upper rail and the lower rail may be adjusted to adjust the distance between the upper press roller and the lower press roller.

The distance between the upper rail and the lower rail may be gradually reduced toward the electrode assembly.

The present disclosure provides a pouch-shaped secondary battery manufactured using the pouch sealing apparatus.

The present disclosure provides a pouch sealing method to seal a pouch for secondary batteries including an upper pouch and a lower pouch, the pouch being configured to receive an electrode assembly and an electrolytic solution, the pouch sealing method including (s1) horizontally locating the upper pouch and the lower pouch having the electrode assembly and the electrolytic solution received therein on a mounting unit and disposing a gas pocket portion of the pouch between a pair of rail units vertically spaced apart from each other, (s2) bringing the gas pocket portions into tight contact with each other while moving a pair of press rollers on the pair of rail units from an end of the gas pocket portion of the pouch in a direction toward the electrode assembly, (s3) moving the pair of press rollers in a direction opposite the electrode assembly so as to be spaced apart from the electrode assembly by a predetermined distance, and (s4) sealing the upper pouch and the lower pouch between the press rollers and the electrode assembly using a sealing unit.

In step (s2), the temperature of each of the press rollers may be increased to bring the gas pocket portions of the pouch into tight contact with each other.

In step (s2), the distance between the pair of rail units may be adjusted to adjust the distance between the pair of press rollers.

In addition, the present disclosure may provide possible combinations of the above solving means.

### Advantageous Effects

As is apparent from the above description, a pouch sealing apparatus according to the present disclosure has an effect in that minimum constructions are added to a conventional pouch sealing apparatus, whereby it is possible to reduce or prevent leakage of an electrolytic solution while minimizing an increase in volume of the apparatus.

In addition, the pouch sealing apparatus according to the present disclosure has an advantage in that the electrolytic solution is removed from a sealed portion, whereby it is possible to improve sealing efficiency.

### DESCRIPTION OF DRAWINGS

FIG. 1 is an outline view of a conventional pouch sealing principle.

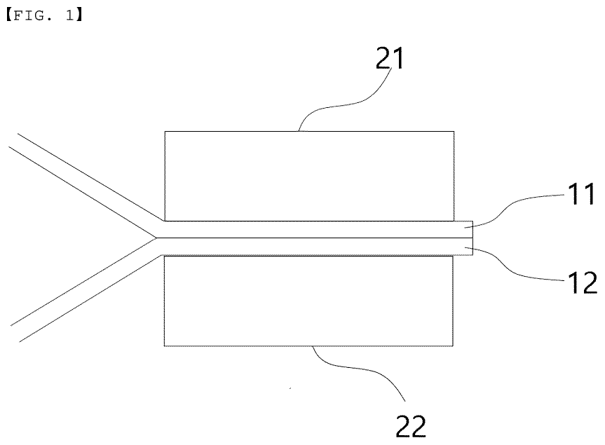

FIG. 2 is an outline view of a pouch sealing apparatus according to an embodiment of the present invention.

FIG. 3 is an outline view of a pouch sealing process according to an embodiment of the present invention.

FIG. 4 is an outline view of a press roller according to an embodiment of the present invention.

FIG. 5 is a schematic view of a pouch after primary sealing using the press roller shown in FIG. 4 and second sealing using a sealing tool have been performed.

### DETAILED DESCRIPTION

Now, preferred embodiments of the present invention will be described in detail with reference to the accompanying drawings such that the preferred embodiments of the present invention can be easily implemented by a person having ordinary skill in the art to which the present disclosure pertains. In describing the principle of operation of the preferred embodiments of the present invention in detail, however, a detailed description of known functions and configurations incorporated herein will be omitted when the same may obscure the subject matter in the present disclosure.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, that a certain element is included does not mean that other elements are excluded, but means that such elements may be further included unless mentioned otherwise.

In addition, a description to embody elements through limitation or addition may be applied to all inventions, unless particularly restricted, and does not limit a specific invention.

Also, in the description in the disclosure and the claims of the present application, singular forms are intended to include plural forms unless mentioned otherwise.

Also, in the description of the disclosure and the claims of the present application, “or” includes “and” unless mentioned otherwise. Therefore, “including A or B” means three cases, namely, the case including A, the case including B, and the case including A and B.

In addition, all numeric ranges include the lowest value, the highest value, and all intermediate values therebetween unless the context clearly indicates otherwise.

Embodiments of the present invention will be described in detail with reference to the accompanying drawings.

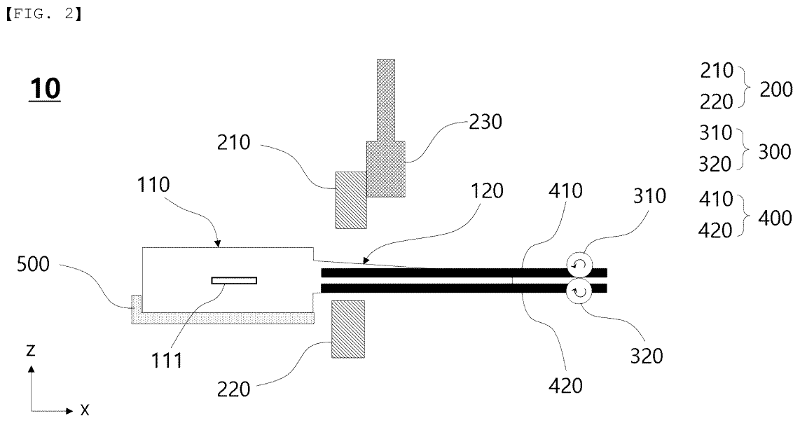

FIG. 2 is an outline view of a pouch sealing apparatus according to an embodiment of the present invention.

Referring to FIG. 2, the pouch sealing apparatus 10 according to the embodiment of the present invention may include a mounting unit 500 configured to allow a pouch receiving portion 110 to be horizontally seated thereon, a sealing tool 200 configured to perform sealing while face-to-face pressing a predetermined position of a gas pocket portion 120 of a pouch, a press roller 300 configured to horizontally move while pressing the gas pocket portion 120 of the pouch in the state in which the gas pocket portion 120 of the pouch is located therebetween, and a rail unit 400 configured to support the press roller 300 and to form a horizontal movement path thereof.

In the present disclosure, a pouch-shaped secondary battery before sealing includes the receiving portion 110, in which an electrode assembly (not shown) is received, and an electrode lead 111.

The electrode assembly may be a jelly-roll type assembly, which is configured to have a structure in which a long sheet type positive electrode and a long sheet type negative electrode are wound in the state in which a separator is interposed therebetween, a stacked type assembly, which is configured to have a structure in which a rectangular positive electrode and a rectangular negative electrode are stacked in the state in which a separator is interposed therebetween, a stacked and folded type assembly, which is configured to have a structure in which unit cells are wound using a long separation film, or a laminated and stacked type assembly, which is configured to have a structure in which battery cells are stacked in the state in which a separator is interposed therebetween and are then attached to each other. However, the present invention is not limited thereto.

Also, it is obvious that an electrolyte may be replaced by a solid electrolyte or a gel type quasi-solid electrolyte obtained by adding an additive to a solid electrolyte, the gel type quasi-solid electrolyte having an intermediate phase between a liquid and a solid, in addition to a liquid electrolyte, which is commonly used.

The electrode assembly is received in the receiving portion 110, and the pouch is generally configured to have a laminate sheet structure including an inner layer, a metal layer, and an outer layer. The inner layer is disposed in direct contact with the electrode assembly, and therefore the inner layer must exhibit high insulation properties and high resistance to an electrolytic solution. In addition, the inner layer must exhibit high sealability in order to hermetically seal the pouch from the outside, i.e. a thermally-bonded sealed portion between inner layers must exhibit excellent thermal bonding strength. The inner layer may be made of a material selected from among a polyolefin-based resin, such as polypropylene, polyethylene, polyethylene acrylate, or polybutylene, a polyurethane resin, and a polyimide resin, which exhibit excellent chemical resistance and high sealability. However, the present disclosure is not limited thereto, and polypropylene, which exhibits excellent mechanical-physical properties, such as tensile strength, rigidity, surface hardness, and impact resistance, and excellent chemical resistance, is the most preferably used.

The metal layer, which is disposed so as to abut the inner layer, corresponds to a barrier layer configured to prevent moisture or various kinds of gas from permeating into the battery from the outside. An aluminum thin film, which is lightweight and easily shapeable, may be used as a preferred material for the metal layer.

The outer layer is provided on the other surface of the metal layer. The outer layer may be made of a heat-resistant polymer that exhibits excellent tensile strength, resistance to moisture permeation, and resistance to air transmission such that the outer layer exhibits high heat resistance and chemical resistance while protecting the electrode assembly. As an example, the outer layer may be made of nylon or polyethylene terephthalate. However, the present invention is not limited thereto.

In an embodiment of the present invention, the pouch before sealing includes the receiving portion, which receives the electrode assembly and the electrolytic solution, and the gas pocket portion 120, which captures gas generated in an activation process.

The mounting unit 500 includes a horizontal support plate (not shown) fixed to a working table or the ground, and the material and shape of the mounting unit are not particularly restricted as long as the mounting unit is capable of stably supporting the pouch receiving portion 110, which is located thereon, so as to be horizontally disposed. A vertical partition wall configured to preventing movement or twisting of the pouch receiving portion 110 in a sealing process may be located, and a fixing means configured to fix the pouch receiving portion 110, which is disposed on the mounting unit, may be further provided.

Next, the sealing tool 200 will be described.

In another embodiment the present invention, the sealing tool 200, which is well known in the art to which the present disclosure pertains, is configured such that an upper sealing device 210 and a lower sealing device 220 are mounted above and under the gas pocket portion 120 of the pouch and such that the upper sealing device 210 and the lower sealing device 220 are moved toward each other to seal the gas pocket portion 120 located therebetween while pressing and heating the gas pocket portion. The sealing tool 200 may include a driving cylinder 230 configured to drive the upper sealing device 210 and the lower sealing device 220 so as to be moved upwards and downwards.

Next, the press roller 300 will be described.

In the present disclosure, the press roller 300 may include an upper press roller 310 and a lower press roller 320 located horizontally while being spaced apart from each other by a predetermined distance.

The upper press roller 310 and the lower press roller 320 are moved from an end (number not shown) of the gas pocket portion 120 to the pouch receiving portion 110 such that the electrolytic solution is introduced into the pouch receiving portion 110. Here, the end of the gas pocket portion 120 may be located between the upper press roller 310 and the lower press roller 320.

Although not shown in the figure, a guide portion (not shown) configured to horizontally flatten the gas pocket portion 120 may be included.

In the present disclosure, the distance between the upper press roller 310 and the lower press roller 320 may be 90% to 150% of the thickness of a laminate sheet that forms the pouch. If the distance between the upper press roller 310 and the lower press roller 320 is less than 90% of the thickness of the laminate sheet, the laminate sheet that forms the gas pocket portion 120 may be damaged in a pressing and rolling process. If the distance between the upper press roller 310 and the lower press roller 320 is greater than 150% of the thickness of the laminate sheet, it is not possible to completely remove the electrolytic solution that remains in the gas pocket portion 120.

Here, each of the upper press roller 310 and the lower press roller 320 may be made of an elastic material. This is advantageous to prevention of damage to the laminate sheet in the process of pressing the laminate sheet that forms the gas pocket portion 120.

Each of the upper press roller 310 and the lower press roller 320 may include a heating member (not shown) such that an outer surface of each of the upper press roller 310 and the lower press roller 320 can be heated up to 250° C., and the heating temperature may be adjusted depending on operating conditions. Laminate sheets located so as to face each other between the upper press roller 310 and the lower press roller 320 heated to a high temperature are heated, whereby facing layers of the laminate sheets are fused to each other. Since the gas pocket portion 120 is fused, as described above, it is possible to prevent reintroduction of the electrolytic solution into the gas pocket portion 120 in a process of performing main sealing using the sealing tool 200, which is advantageous to efficient sealing.

In an embodiment of the present invention, the pouch sealing apparatus 10 may include a rail unit 400 configured to support the upper press roller 310 and the lower press roller 320 and to form movement paths thereof. The rail unit 400 may include an upper rail 410 and a lower rail 420 located horizontally, wherein the upper rail 410 and the lower rail 420 may be located at opposite sides of the gas pocket portion 120 so as to correspond to each other in a direction in which the gas pocket portion 120 extends outwards from the pouch receiving portion 110.

Here, the upper rail 410 and the lower rail 420 may be configured such that the distance therebetween is reduced from the end of the gas pocket portion 120 to the pouch receiving portion 110. This is advantageous to efficient movement of the electrolytic solution to the pouch receiving portion 110 while stably bringing the gas pocket portions 120 into tight contact with each other.

Here, each of the upper rail 410 and the lower rail 420 may be formed in the shape of a groove that is concave in the middle thereof in a lateral direction (y-axis direction), and each of the upper press roller 310 and the lower press roller 320 located respectively on the upper rail 410 and the lower rail 420 may be provided with a protrusion (not shown) configured to be inserted into the groove. As a result, the upper press roller 310 and the lower press roller 320 are movable on the upper rail 410 and the lower rail 420 corresponding thereto only in a forward-rearward direction (x-axis direction) based on the pouch receiving portion 110 but are not movable in a leftward-rightward direction (y-axis direction), whereby it is possible to prevent twisting of or damage to the gas pocket portion 120 located between the upper press roller 310 and the lower press roller 320.

Although not shown in the figure, a distance adjustment portion (not shown) configured to adjust the distance between the upper rail 410 and the lower rail 420 may be provided, wherein the distance adjustment portion may move the upper rail 410 and/or the lower rail 420 upwards and downwards to adjust the distance therebetween. As described above, the distance between the upper press roller 310 and the lower press roller 320 may be adjusted through adjustment of the distance between the upper rail 410 and the lower rail 420, whereby it is possible to adjust the force of pressing against the gas pocket portion 120.

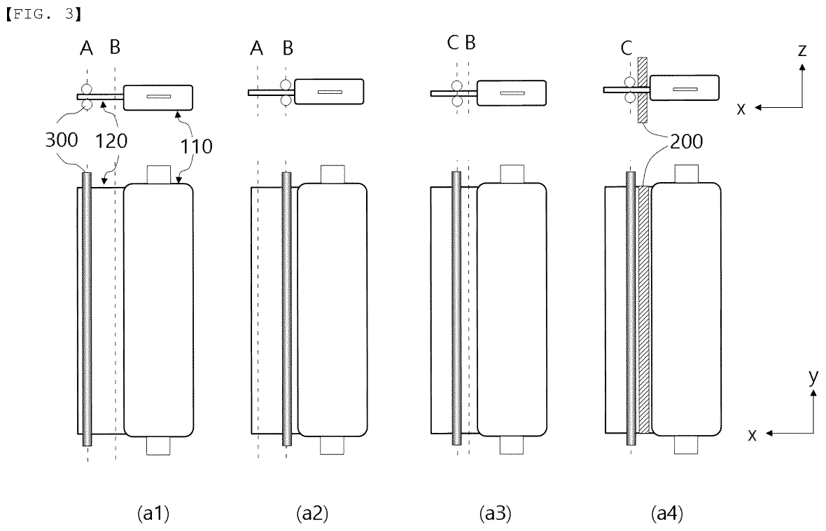

FIG. 3 is an outline view of a pouch sealing process according to an embodiment of the present invention.

A pouch sealing method according to an embodiment of the present invention will be described with reference to FIG. 3.

In the pouch sealing method according to the embodiment of the present invention, a pouch having an electrode assembly received in a pouch receiving portion 110 is prepared, the pouch receiving portion 110 is horizontally seated on the mounting unit 500, and an end of a gas pocket portion 120 formed as the result of extending from the pouch receiving portion 110 is horizontally disposed so as to be located between the upper press roller 310 and the lower press roller 320 of the press roller 300.

As shown in (a1) of FIG. 3, the upper press roller 310 and the lower press roller 320 are located on and under the gas pocket portion 120 at position A of the end of the gas pocket portion. FIG. 3 shows that position A is distant from the end of the gas pocket portion 120 that faces the pouch receiving portion 110 toward the pouch receiving portion 110 by a predetermined distance; however, position A may be located at the end of the gas pocket portion 120 or at an outside portion spaced apart from the end of the gas pocket portion 120 so as to be opposite the pouch receiving portion 110. Position A is not particularly restricted as long as it is possible to push an electrolytic solution in the gas pocket portion 120 so as to be introduced into the pouch receiving portion 110.

The upper press roller 310 and the lower press roller 320, each of which has been heated to a predetermined temperature, move to position B, which is maximally adjacent to the pouch receiving portion 110, while rolling toward the pouch receiving portion 110 in a state of pressing the gas pocket portion 120 disposed therebetween (a2). In this process, the gas pocket portion 120 is heated while being pressed by the upper press roller 310 and the lower press roller 320, whereby the gas pocket portion 120 is fused. In addition, the electrolytic solution that remains in the gas pocket portion 120 is moved toward the pouch receiving portion 110 by pressing of the upper press roller 310 and the lower press roller 320, and is finally introduced into the pouch receiving portion 110.

In another embodiment of the present invention, the upper press roller 310 and the lower press roller 320 are rotated in opposite directions while facing each other.

Subsequently, the upper press roller 310 and the lower press roller 320 located at position B move a predetermined distance in an extension direction of the gas pocket portion 120 that is distant from the pouch receiving portion 110 and is located at position C (a3). Here, position C is located between position A and position B, and the upper press roller 310 and the lower press roller 320 serve to fix the gas pocket portion 120 located therebetween.

In spaces between the upper press roller 310 and the lower press roller 320 located at position B and the pouch receiving portion 110, the upper sealing device 210 and the lower sealing device 220, each of which has been heated to a predetermined temperature, seals the gas pocket portion 120 located therebetween at a sealing position thereof while moving in a state of being opposite each other, whereby it is possible to increase the force of sealing the pouch and to prevent the occurrence of defects (a4).

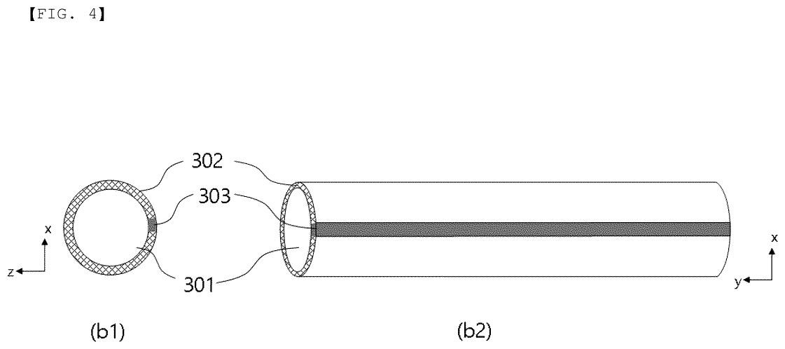

FIG. 4 is an outline view of a press roller according to an embodiment of the present invention. FIG. is a schematic view of a pouch after primary sealing using the press roller shown in FIG. 4 and secondary sealing using the sealing tool have been performed.

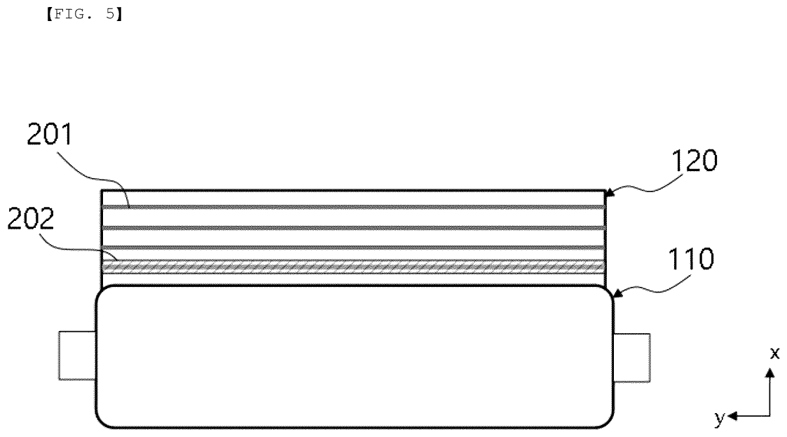

The press roller 300 according to the embodiment of the present invention will be described in detail with reference to FIGS. 4 and 5.

(b1) of FIG. 4 is a side view of the press roller 300, and (b2) of FIG. 4 is a front view of the press roller 300. Referring to FIG. 4, the press roller 300 may include a roller portion 301 that forms a central axis thereof and an outer cover portion (not shown) formed so as to wrap an outer curved surface of the roller portion 301. The outer cover portion may include a heat dissipation portion 302 and a heating portion 303, wherein the heating portion 303 may be formed at a part of the outer cover portion so as to be parallel to the central axis of the press roller 300. The heating portion 303 may be provided with an additional heating member configured to increase the temperature of the heating portion 303. Here, an outer surface of the heating portion 303 may face the gas pocket portion 120 when the press roller 300 rolls and may primarily seal a facing region of the gas pocket portion 120. In addition, the heat dissipation portion 302 may be located at an outer periphery of the heating portion 303 to prevent heat of the heating portion 303 from being transferred to a part of the outer cover portion of the press roller 300 other than the heating portion 303.

The press roller 300 may have a diameter of 5 mm to 100 mm, and in (b1) of FIG. 4, the length of the outermost circumference of the heating portion 303 may be 1/30 to ½ of the length of the circumference of the press roller 300. As a result, the heating portion 303 is formed at only a part of the press roller 300, which is advantageous to prevention of excessive heating of the gas pocket portion 120 and damage to the gas pocket portion. In addition, one or more heating portions 303 may be disposed at an outer circumferential surface of the press roller 300 so as to be spaced apart from each other by a predetermined distance.

In an embodiment of the present invention, the heating portion 303 may be provided at one of the upper press roller 310 and the lower press roller 320, or may be provided at each of the upper press roller 310 and the lower press roller 320.

Referring to FIG. 5, the press roller 300 may primarily seal a part of the gas pocket portion 120 that faces the heating portion 303 while rolling from the end of the gas pocket portion 120 toward the pouch receiving portion 110 to form a primarily sealed portion 201. When the press roller 300 rolls on an outer surface of the gas pocket portion 120, the pouch constituting the gas pocket portion 120 is pressed toward the pouch receiving portion 110, whereby an electrolytic solution that remains in the gas pocket portion 120 moves toward the pouch receiving portion 110. In addition, the primarily sealed portion 201 is formed by the heating portion 303, whereby it is possible to prevent movement of the electrolytic solution to the outside. The press roller 300 may form one or more primarily sealed portions 201 while rolling outside the gas pocket portion 120. In another embodiment of the present invention, the sealing tool 200 may secondarily seal the primarily sealed portion 201 formed the closest to the pouch receiving portion 110 to form a secondarily sealed portion 202. Consequently, uniform and quality guaranteed sealing having a regular thickness and width is achieved with respect to the pouch.

In an embodiment of the present invention, the sealing temperature of the heating portion 303 formed at the press roller 300 may be lower than the sealing temperature of the sealing tool 200, and the pressing pressure of the press roller 300 applied to the gas pocket portion 120 may be lower than the pressing pressure of the sealing tool 200 applied to the gas pocket portion 120.

Although the specific details of various embodiments of the present invention have been described in detail, those skilled in the art will appreciate that the detailed description thereof discloses only preferred embodiments of the present invention and thus does not limit the scope of the present invention. Accordingly, those skilled in the art will appreciate that various changes and modifications are possible, without departing from the category and technical idea of the present disclosure, and it will be obvious that such changes and modifications fall within the scope of the appended claims.

### DESCRIPTION OF REFERENCE NUMERALS

10: Pouch sealing apparatus
11: Upper pouch
12: Lower pouch
21: Upper sealing tool
22: Lower sealing tool
110: Pouch receiving portion
111: Electrode lead
120: Gas pocket portion
200: Sealing tool
201: Primarily sealed portion
202: Secondarily sealed portion
210: Upper sealing device
220: Lower sealing device
230: Cylinder
300: Press roller
301: Roller portion
302: Heat dissipation portion
303: Heating portion
310: Upper press roller
320: Lower press roller
400: Rail unit
410: Upper rail
420: Lower rail
500: Mounting unit

1. A pouch sealing apparatus configured to seal a pouch for batteries, the pouch including an upper pouch and a lower pouch, the pouch being configured to receive an electrode assembly and an electrolytic solution, the pouch sealing apparatus comprising:
a mounting unit configured to seat a pouch receiving portion thereon;
a press roller configured to move the electrolytic solution into the pouch receiving portion while the press roller rolls from open ends of the upper pouch and the lower pouch toward the pouch receiving portion; and
a sealing tool configured to seal parts of the upper pouch and the lower pouch to be sealed,
the press roller is configured to fuse the upper pouch and the lower pouch in contact with each other, wherein the press roller includes a heating portion.

2. The pouch sealing apparatus according to claim 1, wherein the press roller comprises an upper press roller and a lower press roller, the upper press roller and the lower press roller being positioned such that the parts of the upper pouch and the lower pouch to be sealed are disposed therebetween.

3. The pouch sealing apparatus according to claim 2, wherein
the heating portion of at least one of the upper press roller and the lower press roller is configured to heat to a temperature up to 250° C., and
the upper press roller and the lower press roller are spaced apart from each other by a predetermined distance.

4. The pouch sealing apparatus according to claim 2, wherein
the upper press roller is located at upper ends positioned between a pair of upper rails, the upper rails being horizontally spaced apart from each other by a predetermined distance,
the lower press roller is located at upper ends positioned between a pair of lower rails, the lower rails being horizontally spaced apart from each other by a predetermined distance,
wherein the pair of upper rails and the pair of lower rails are located so as to oppose each other,
wherein the upper press roller is disposed between the pair of upper rails, the upper press roller being configured to roll along a direction parallel to a longitudinal dimension of the upper rails, and
wherein the lower press roller is disposed between the pair of lower rails, the lower press roller being configured to roll along a direction parallel to a longitudinal dimension of the lower rails.

5. The pouch sealing apparatus according to claim 4, wherein a vertical distance between the pair of upper rails and the pair of lower rails is configured to adjust a distance between the upper press roller and the lower press roller.

6. The pouch sealing apparatus according to claim 4, wherein the predetermined distance between the pair of upper rails and the pair of lower rails is configured to be gradually reduced along a direction extending toward the electrode assembly.

7. A pouch-shaped secondary battery manufactured using the pouch sealing apparatus according to claim 1, and an electrolyte.

8. A pouch sealing method to seal a pouch for secondary batteries comprising an upper pouch and a lower pouch, the pouch being configured to receive an electrode assembly and an electrolytic solution, the pouch sealing method comprising:
(s1) horizontally locating the upper pouch and the lower pouch on a mounting unit and disposing a gas pocket portion of the pouch between a pair of rail units, the pair of rail units being vertically spaced apart from each other, the rail units each including a pair of rails, the rails in each pair being horizontally spaced apart from each other by a predetermined distance;
(s2) bringing the upper pouch of the gas pocket portion and the lower pouch of the gas pocket portion into tight contact with each other while moving a pair of press rollers on the pair of rail units from an end of the gas pocket portion of the pouch in a direction toward the electrode assembly;
(s3) moving the pair of press rollers in a direction away from the electrode assembly, so as to space the pair of press rollers apart from the electrode assembly by a predetermined distance; and
(s4) sealing the upper pouch and the lower pouch at a position located between the press rollers and the electrode assembly using a sealing unit.

9. The pouch sealing method according to claim 8, wherein a temperature of each of the press rollers is increased to bring the upper pouch and the lower pouch of the gas pocket portions into tight contact with each other.

10. The pouch sealing method according to claim 8, wherein a distance between the pair of rail units is adjusted to adjust a distance between the pair of press rollers.
